(19) United States
(12) Patent Application Publication
(10) Pub. No.: US 2004/0080217 A1
(43) Pub. Date: Apr. 29, 2004

(54) Vacuum-use motor

(76) Inventors: Nobuhiko Ota, Fukuoka (JP); Toshikazu Hamao, Fukuoka (JP); Yoshifusa Tsubone, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/471,180

(22) PCT Filed: Mar. 7, 2002
(86) PCT No.: PCT/JP02/02160

(30) Foreign Application Priority Data
Mar. 13, 2001 (JP) 2001-70899

(51) Int. Cl. H02K 41/00

(52) U.S. Cl. 310/12

(57) ABSTRACT

It is an object to provide a vacuum motor in which outgassing rate from a resin is low, the outgassing to contaminate a vacuum environment is lessened, and furthermore, the loss of an eddy current is decreased even if the vacuum motor is exposed to the vacuum environment.

In a motor for a vacuum use in which at least a part is constituted by a can (102) formed of a resin or a motor for a vacuum use which has a coil molded with a resin, at least a part of a surface of the resin is covered with an inorganic film (107) and a metal, ceramics or electroless nickel plating is suitable for the inorganic film. Thus, the motor for a vacuum use can be applied to a vacuum linear motor.

### TECHNICAL FIELD

The present invention relates to a motor for a vacuum use, which drives the linear stage of a semiconductor manufacturing apparatus to be used in a vacuum environment.

### BACKGROUND ART

In an apparatus to be used in a vacuum environment, an outgassing is required to be lessened. The outgassing in a vacuum is caused by desorbing a substance adsorbed onto the surface of a material and diffusing the gas desorbed into the material. Therefore, the apparatus to be used in the vacuum environment is constituted by a material from which the outgassing becomes less.

Referring to a motor according to the invention, there has been proposed a linear motor having a can structure which is constituted by hardening a glass cloth with an epoxy resin which has been described in JP-A-2000-4572.

FIG. 9 is an explanatory view showing the structure of a conventional can, and 101 denotes a housing, 102 denotes a can and 106 denotes a resin plate. In the conventional linear motor, the can structure shown in wig. 9 has been employed.

In this example, the resin plate 106 is constituted by a resin filled with a glass fiber or a resin filled with a carbon fiber. Consequently, it is possible to increase a Young's modulus, to reduce a thickness and to decrease the weight of the motor. In this example, moreover, it is possible to cool an armature winding by causing the florinart of a refrigerant to flow through a refrigerant passage.

On the other hand, if a metal from which a outgassing is lessened is used, an eddy current is generated so that a motor loss is increased.

FIG. 10 is a sectional side view showing an axial gap motor for a vacuum use according to a conventional example. In FIG. 10, 1 denotes a stator core, 2 denotes a coil, 3 denotes a mold resin, and 4 denotes a stator housing. In the use of low and middle vacuum regions, as in this example, there has been used a motor having a coil structure in which the mold resin 3 is exposed into a vacuum. In the motor for a vacuum use shown in FIG. 10, the outgassing rate from the resin 3 molding the coil 2 is high and an ultimate pressure is raised. In the use of a high vacuum region, therefore, a degree of vacuum to be a target cannot be obtained. Furthermore, there is a problem in that an organic gas is discharged from the resin 3, resulting in the contamination of a vacuum environment.

Therefore, there has been executed a well-known technique in which a mold resin is covered with a metallic can in order to reduce the outgassing rate. By covering the mold resin with the metallic can, the adsorption and absorption of steam in the air is extremely lessened as compared with the mold resin. Consequently, it is possible to considerably reduce the outgassing rate in a vacuum.

However, when the conventional linear motor using the can formed of a resin is utilized for the linear stage driving of a semiconductor exposing apparatus in a vacuum environment, a gas is discharged by desorbing a gas adsorbed onto the surface of the can and diffusing a gas occluded in the can onto a surface. In general, outgassing rate from a resin is high. Therefore, there is a problem in that an ultimate pressure to be a target cannot be obtained.

Furthermore, there is a problem in that an organic outgassing from a resin contaminates a vacuum environment, and a silicon wafer and the inside of an apparatus.

In the metallic can structure, moreover, a outgassing rate is low and an organic gas is not discharged. However, an eddy current loss is generated, resulting in a deterioration in the characteristic of the motor, and furthermore, manufacture is hard to fabricate. Therefore, there is a problem in that a cost is increased.

On the other hand, in the conventional motor for a vacuum use shown in FIG. 10, the outgassing rate from the resin molding the coil is high as described above, and the ultimate pressure is raised so that a degree of vacuum to be a target cannot be obtained. Furthermore, there is a problem in that an organic gas is discharged from the resin, resulting in the contamination of a vacuum environment.

### DISCLOSURE OF THE INVENTION

The present invention has been made in consideration of these problems and has an object to provide a vacuum motor in which the outgassing rate from a resin is low, the generation of a gas to contaminate a vacuum environment is lessened, and furthermore, the loss of an eddy current is decreased even if the vacuum motor is exposed to the vacuum environment.

In order to attain the object, the invention provides a motor for a vacuum use in which at least a part is constituted by a can formed of a resin, wherein at least a part of a surface of the resin is covered with an inorganic film.

Moreover, the invention provides a motor for a vacuum use which has a coil molded with a resin, wherein a surface to be exposed to a vacuum atmosphere of the resin is covered with an inorganic film.

A metal, ceramics or electroless plating is suitable for the inorganic film. Furthermore, the invention can be applied to a linear motor.

As described above, in the vacuum motor according to the invention, at least a part of the surface of the resin is covered with the inorganic coat. When the vacuum motor is used for the linear stage driving of a semiconductor exposing apparatus in a vacuum environment, therefore, the outgassing rate from a can is reduced, an ultimate pressure can be decreased considerably and an organic gas is not discharged. Consequently, the vacuum environment can be prevented from being contaminated.

Together with the advantages, the invention can also be applied to a motor for the use of chemical clean.

### BRIEF DESCRIPTION OF THE DRAWINGS

FIG. 1 is an explanatory view showing the structure of a can according to the invention.

FIG. 2 is a sectional side view showing a stator according to the invention.

FIG. 3 is a perspective view showing a linear motor according to the invention.

FIG. 4 is a sectional front view showing the linear motor according to an embodiment of the invention.

FIG. 5 is a characteristic chart showing a pressure in which a gas is evacuated from a motor according to a first embodiment of the invention and a motor according to a conventional example through a vacuum apparatus.

FIG. 6 is a characteristic chart showing a gas component to be discharged when a gas is evacuated from the motor according to the first embodiment of the invention and the motor according to the conventional example through the vacuum apparatus.

FIG. 7 is a characteristic chart showing a pressure when a gas is evacuated from a motor according to a second embodiment of the invention and the motor according to the conventional example through the vacuum apparatus.

FIG. 8 is a characteristic chart showing a gas component to be discharged when a gas is evacuated from the motor according to the second embodiment of the invention and the motor according to the conventional example through the vacuum apparatus.

FIG. 9 is an explanatory view showing the structure of a conventional can.

FIG. 10 is an explanatory view showing the structure of the conventional can.

### BEST MODE OF CARRYING OUT THE INVENTION

In the invention, the covering with an inorganic film is carried out for the following reasons. In general, a gas is less adsorbed and occluded onto or into the surface of an inorganic material such as a metal or ceramics, and a outgassing rate in a vacuum is lower as compared with a resin. In the inorganic material such as a metal or ceramics, moreover, the material does not have an organic gas and the generation of the organic gas to contaminate a vacuum atmosphere is lessened.

In case of a linear motor in which electric loading means having a winding is a stator and magnetic loading means constituted by a permanent magnet is a moving member, particularly, the surface area of a can covering the stator is comparatively increased. Therefore, the effect of reducing a problem of a discharged gas is enhanced still more.

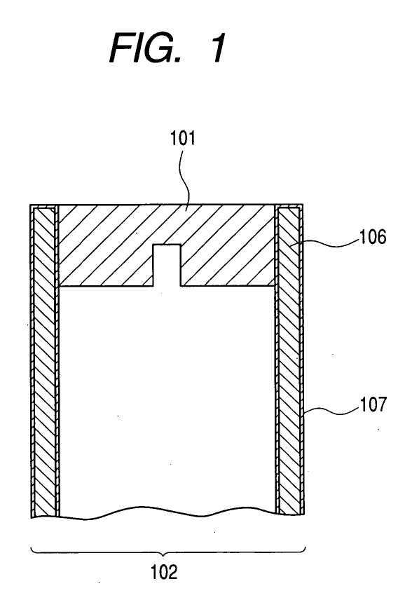

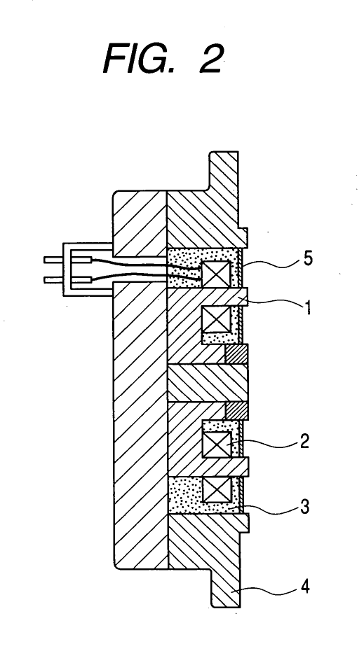

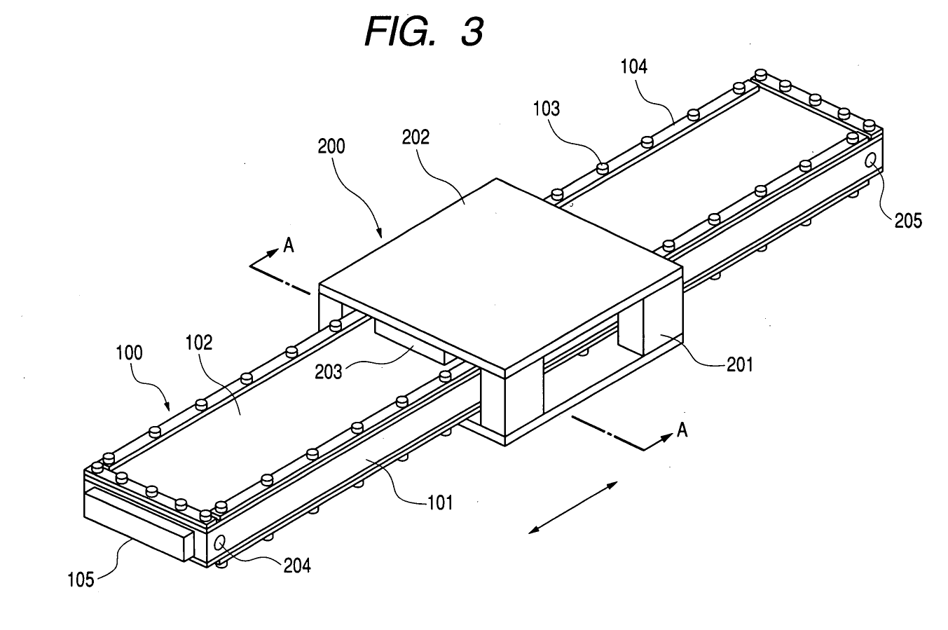

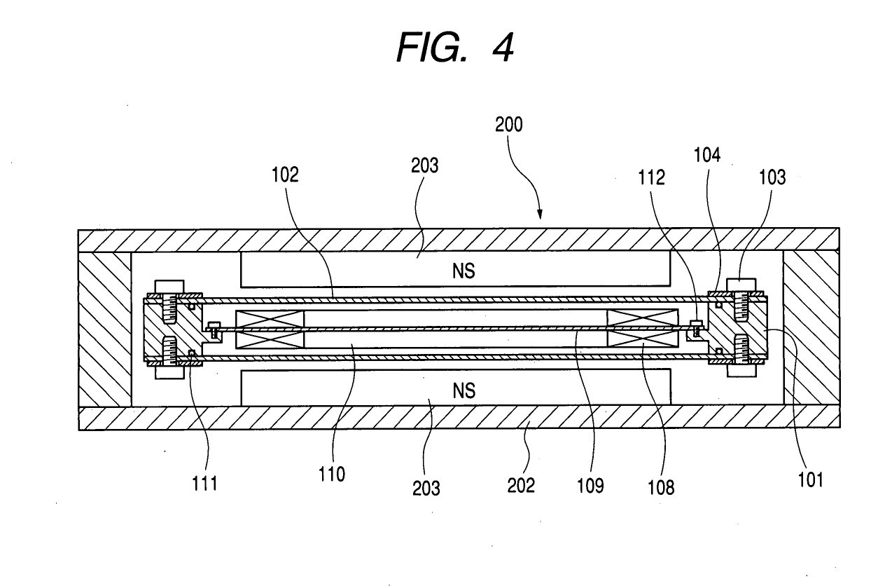

Next, an embodiment of the invention will be described in detail with reference to the drawings. FIG. 1 is an explanatory view showing the structure of a can according to the invention, FIG. 2 is a sectional side view showing the stator of an axial gap motor for a vacuum use according to the embodiment of the invention, FIG. 3 is a perspective view showing a linear motor according to the embodiment of the invention, and FIG. 4 is a sectional front view.

In FIG. 3, 100 denotes a stator, 101 denotes a housing, 102 denotes a can, 103 denotes a bolt for can fixation, 104 denotes a presser plate, 105 denotes a terminal table, 204 denotes a refrigerant feeding port, 205 denotes a refrigerant discharge port, 200 denotes a movable member, 201 denotes a field yoke support member, 202 denotes a field yoke and 203 denotes a permanent magnet.

In the movable member 200, the armature of the stator 100 is provided between the permanent magnets 203 and is supported by a linear guide, an air slider or a slip guide which is not shown. When a predetermined current flows to an armature winding, the thrust of the movable member 200 is generated by an action with a magnetic field made by the permanent magnet 203 and the movable member 200 is moved in the direction of advance shown in an arrow.

In FIG. 4, the stator 100 is constituted by a square metal housing 101 having a hollow inner part, a plate-shaped can 102 formed of a resin which has the external shape of the housing 101, a bolt 103 for can fixation which serves to fix the can 102 to the housing 101, a presser plate 104 having a though hole for the bolt 103 for can fixation and serving to press the can with an equal load, a 3-phase armature winding 108 provided in the hollow part of the housing 101, a winding fixing frame 109 fixing the armature winding 108, a refrigerant passage 110 through which a refrigerant passes through the housing 101 and the can 102, an O ring 111 having a slightly larger size than that of the edge of the housing 101, and a bolt 112 for winding fixation which serves to fix the winding fixing frame 109 and the housing 101.

In FIG. 1, the can 102 is constituted by a resin plate 106 and the housing 101, and an inorganic coat 107 is provided on the surface of the resin plate 106. In the embodiment, GFRP obtained by hardening a glass cloth with an epoxy resin or CFRP obtained by hardening a carbon fiber with the epoxy resin is used for the resin plate 106.

In the embodiment of the invention, moreover, electric loading means constituted by the armature winding 108 is set to be the stator 100 and magnetic loading means constituted by the permanent magnet 203 is set to be the movable member 200, and it is a matter of course that the reverse can also be set up.

FIG. 2 is a sectional side view showing the stator of an axial gap motor for a vacuum use according to the embodiment of the invention. A coil 2 obtained by impregnating a stator core 1 subjected to insulation to the earth with varnish is inserted and a resin 3 having a high viscosity is then molded and cured at 150° C. The surface of the mold 3 of the stator thus insulated is provided with an inorganic film 5. 4 denotes a stator housing.

First Embodiment

In the embodiment, an inorganic film 107 is subjected to an electroless nickel plating film. If the thickness of a metal film such as nickel is too small, a defect penetrating through the resin of a substrate such as a pin hole is generated and a gas is discharged from the penetrating defect portion, which is not preferable. If the same thickness is too great, moreover, an eddy current loss is increased or a crack or peeling is apt to be caused, which is not preferable. Accordingly, it is proper that the thickness of the film of the electroless nickel plating ranges from 0.5 μm to 50 μm. In order to enhance an adhesion, it is preferable that a surface should be made rough by a shot blasting treatment before the plating treatment. Although only the surface of the resin to be exposed to a vacuum may be covered with the plated film, outgassing from a small clearance of a boundary surface with a housing. Therefore, it is desirable that the whole surface of the resin should be covered as shown in FIG. 1.

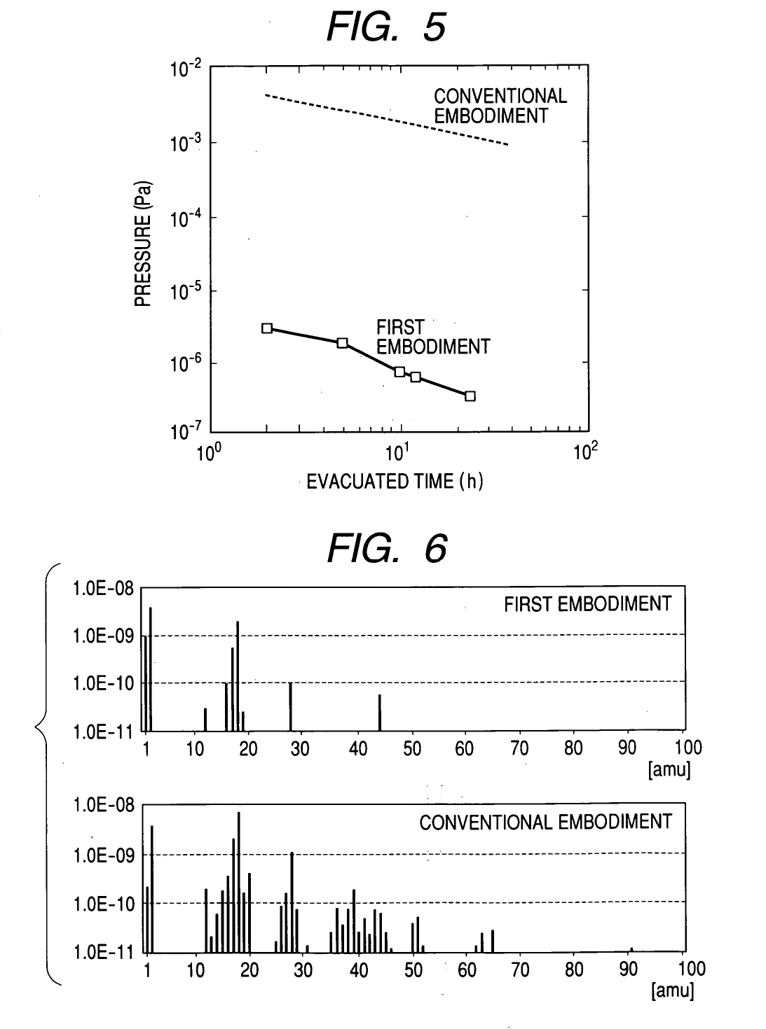

FIG. 5 is a characteristic chart showing a relationship between an evacuated time and a pressure which is obtained when a gas is evacuated at a room temperature in a vacuum apparatus incorporating a linear motor according to the embodiment which is thus subjected to the electroless nickel plating treatment and a linear motor (an untreated product) which is not subjected to the electroless nickel plating treatment as a conventional example. In the case in which the linear motor subjected to the electroless nickel plating treatment is incorporated, the pressure is decreased by approximately three orders of magnitude as compared with that of the conventional example.

FIG. 6 shows an example in which a gas component discharged in a vacuum environment is examined by a quadrupole mass spectrometer in a vacuum apparatus incorporating the linear motor according to the embodiment which is subjected to the electroless nickel plating and the linear motor (the untreated product) which is not subjected to the electroless nickel plating as the conventional example. While the discharge of an organic gas having a mass number of approximately 28 or 40 or a mass number of 50 or more was found in the conventional example, the discharge of the organic gas is not found at all in the embodiment.

As means for providing a film 5 of a metal, it is also possible to use a method such as a hot dipping method, a vacuum evaporation method or a thermal spraying method in addition to the electroless plating. Moreover, it is also possible to use aluminum, copper, gold or silver in addition to nickel for the material of the metal.

Second Embodiment

In a second embodiment, titanium nitride (TiN) is given as an inorganic film 5 by an ion plating treatment. If the thickness of a ceramics film such as titanium nitride is too small, a defect penetrating through the resin of a substrate such as a pinhole is generated and outgassing from the penetrating defect portion, which is not preferable. If the same thickness is too great, moreover, a crack or peeling is apt to be caused, which is not preferable. Accordingly, it is proper that the thickness of the film of the titanium nitride ranges from 0.5 μm to 50 μm. In order to enhance an adhesion, it is preferable that a surface should be made rough by a shot blasting treatment before the ion plating. Although only the surface of a resin to be exposed to a vacuum may be covered with the ion plating film through masking, it is desirable that the whole surface of the resin should be covered as shown in FIG. 1 because the outgassing from a small clearance of a boundary surface with a housing.

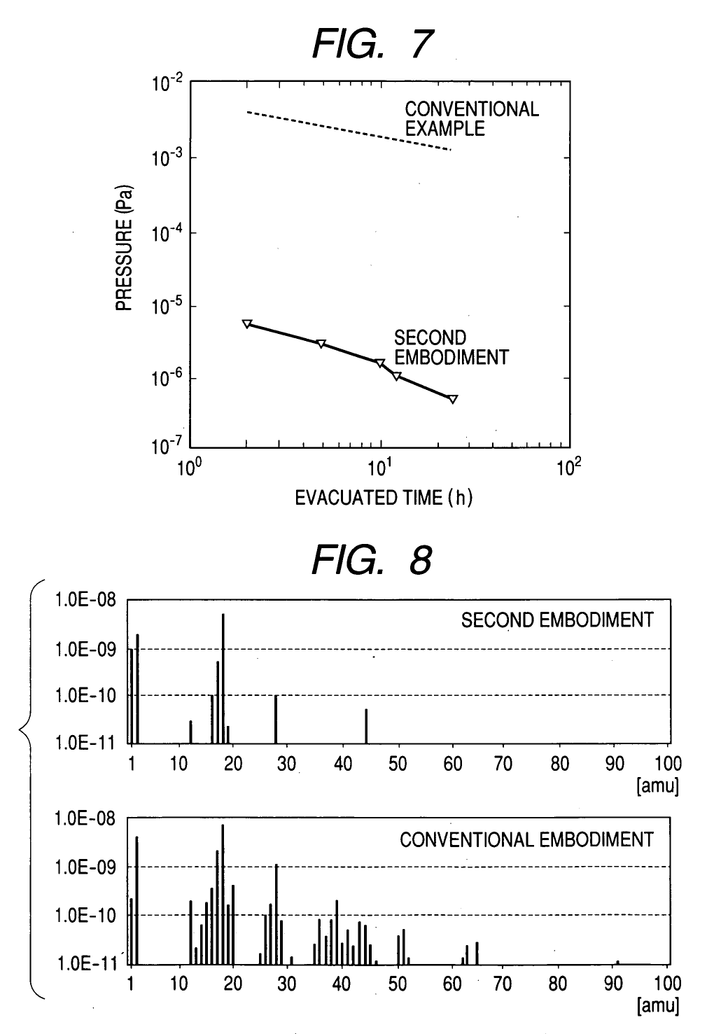

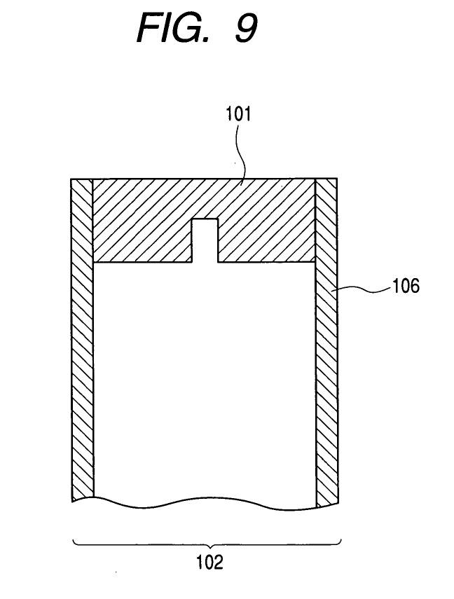

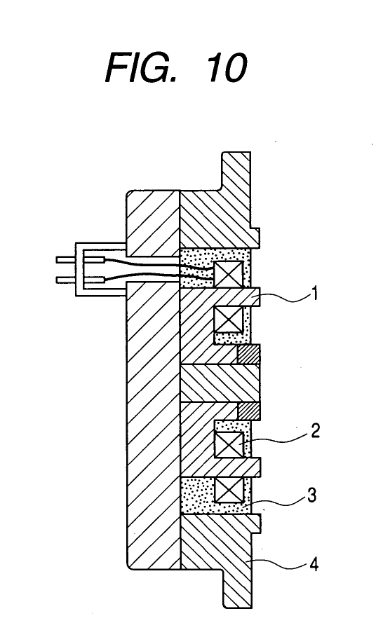

FIG. 7 is a characteristic chart showing a relationship between an evacuated time and a pressure which is obtained when a gas is evacuated at a room temperature in a vacuum apparatus incorporating a linear motor according to the embodiment which is thus subjected to the TiN ion plating treatment and a linear motor (an untreated product) which is not subjected to the TiN ion plating treatment as a conventional example. In the case in which the linear motor subjected to the TiN ion plating treatment is incorporated, the pressure is decreased by approximately three orders of magnitude as compared with the conventional example.

FIG. 8 shows an example in which a gas component discharged in a vacuum environment is examined by a quadrupole mass spectrometer in a vacuum apparatus incorporating the linear motor according to the embodiment which is subjected to the TiN ion plating treatment and the linear motor (the untreated product) which is not subjected to the TiN ion plating treatment as the conventional example. While the discharge of an organic gas having a mass number of approximately 28 or 40 or a mass number of 50 or more was found in the conventional example, the discharge of the organic gas is not found at all in the embodiment.

As means for providing a film of ceramics, it is also possible to use a method such as a sol-gel method, a plasma CVD method or a thermal spraying method in addition to the ion plating treatment. Moreover, it is also possible to use silicon dioxide (SiO₂), alumina (AlO₃) or diamond-like carbon (DLC) in addition to the TiN for the metal of the ceramics.

### INDUSTRIAL APPLICABILITY

In the vacuum motor according to the invention, at least a part of the surface of a resin is covered with an inorganic film. When the vacuum motor is used for the linear stage driving of a semiconductor exposing apparatus in a vacuum environment, therefore, outgassing rate from a can is reduced, an ultimate pressure can be dropped considerably and an organic gas is not discharged. Consequently, a vacuum environment can be prevented from being contaminated.

Together with the advantages, the invention can also be applied to a motor for the use of chemical clean.

1. A motor for a vacuum use in which at least a part is constituted by a can formed of a resin, wherein at least a part of a surface of the resin is covered with an inorganic film.

2. A motor for a vacuum use which has a coil molded with a resin, wherein a surface to be exposed to a vacuum atmosphere of the resin is covered with an inorganic film.

3. The motor for a vacuum use according to claim 1, wherein the inorganic film is a metal.

4. The motor for a vacuum use according to claim 1, wherein the inorganic film is ceramics.

5. The motor for a vacuum use according to claim 1, wherein the inorganic film is fabricated by a electroless nickel plating method.

6. The motor for a vacuum use according to any of claims 1 to 5, wherein the motor for a vacuum use is a linear motor.
